(19) United States
(12) Patent Application Publication
(10) Pub. No.: US 2013/0110987 A1
(43) Pub. Date: May 2, 2013

(54) APPARATUS AND METHOD FOR PROVIDING CONTENT LOCATION INFORMATION USING OSPF OPAQUE LSA

(71) Applicant: Electronics and Telecommunications Research, Daejeon-si (KR)

(72) Inventors: Byeong-Sik KIM, Daejeon-si (KR); Byung-Joon LEE, Daejeon-si (KR); Ho-Young SONG, Daejeon-si (KR)

(73) Assignee: Electronics and Telecommunications Research Institute, Daejeon-si (KR)

(21) Appl. No.: 13/665,039

(22) Filed: Oct. 31, 2012

(30) Foreign Application Priority Data
Oct. 31, 2011 (KR) 10-2011-0112423
Jun. 29, 2012 (KR) 10-2012-0071047

(51) Int. Cl. G06F 15/16; G06F 17/30

(52) U.S. Cl. 709/219; 707/769; 707/E17.014

(57) ABSTRACT

A system for providing content location information is provided, and the system includes at least one router-storage apparatus configured to be connected to a storage, generate Opaque Link State Advertisement (LSA) including content location information of content items stored in the storage and flood the generated Opaque LSA to at least one adjacent router and at least one content location finding apparatus configured to be connected to the at least one router-storage apparatus, acquire the content location information, store content location information in a content location information database (DB), search for location information of a content item requested from a user terminal in the content location information DB and provide the found content location information.

### CROSS-REFERENCE TO RELATED APPLICATION

This application claims the benefit under 35 U.S.C. §119(a) of Korean Patent Application Nos. 10-2011-0112423, filed on Oct. 31, 2011 and 10-2012-0071047, filed on Jun. 29, 2012, the entire disclosure of which is incorporated by reference in its entirety for all purposes.

### BACKGROUND

1. Field

The present invention is related to an apparatus and a method for providing content, and more particularly, to an apparatus and a method for providing content location information using an Open Shortest Path First (OSPF) Opaque Link State Advertisement (LSA) in a distributed router.

2. Description of the Related Art

A conventional method for providing content is downloading content stored in a predetermined server in response to a user's request. However, as mass-storage content, such as video, is widely used and smart phones have gained popularity, an unprecedented amount of content is requested to be downloaded.

This trend has overloaded content servers for storing and downloading content and led to heavy traffic on networks connected to the content servers so that transmission pace may slow down.

In order to solve the above problem, researches have been conducted on technologies wherein a data transmission device, such as a router and a switch, has a storage to store or cache content so as to prevent the cloud server from being overloaded and the content is received from a router most adjacent to a user terminal requesting the content. Therefore, such technologies require a method for providing content location information notifying in which storage the content is stored.

### SUMMARY

The present invention is related to an apparatus and a method for sharing location information about a storage storing content with routers on a network composed the routers, each having a storage.

The present invention is related to an apparatus and a method for finding location information about a storage configured to store a content item requested from a user on a network composed of a plurality of routers and then providing the location information.

The present invention is a router-storage apparatus, and the router-storage apparatus includes a storage configured to store at least one content item and a router configured to be connected to the storage, generate an Opaque Link State Advertisement (LSA) including content location information of content items stored in the storage and flood the generated Opaque LSA to at least one adjacent router.

The present invention is related to a content location finding apparatus, and the content location finding apparatus includes a content location information acquiring unit configured to acquire content location information from a router on a network and store the content location information in a content location information database (DB) and a content location information searching unit configured to search for content location information of a content item requested from a user terminal in the content location information DB and provide the found content location information.

The present invention is related to a method for sharing content location information with at least one router, and the method includes generating an Opaque LSA which includes content location information of content items stored in a storage and flooding the generated Opaque LSA to at least one adjacent router.

The present invention is related to a method for finding content location in a content location finding apparatus connected to a content location information DB, and the method includes acquiring content location information from a router on a network and storing the content location information in the content location information DB, and searching for content location information of a content item requested from a user terminal in the content location information DB and providing the found content location information.

The present invention is related to a system for providing content location information, the system includes at least one router-storage apparatus configured to be connected to a storage, generate an Opaque LSA including content location information of content items stored in the storage and flood the generated Opaque LSA to at least one adjacent router, and at least one content location finding apparatus configured to be connected to the at least one router-storage apparatus, acquire content location information, store the content location information of content items stored in a content location information DB, search for content location information of a content item requested from a user terminal in the content location information DB and provide the found content location information.

### BRIEF DESCRIPTION OF THE DRAWINGS

FIG. 1 is a diagram illustrating a configuration of a network system composed of a plurality of routers, each having a storage, according to an exemplary embodiment of the present invention;

FIG. 2 is a diagram illustrating a format of a general Open Shortest Path First (OSPF) Link State Advertisement (LSA);

FIG. 3 is a diagram illustrating a format of an OSPF Opaque LSA applied in the present invention;

FIG. 4 is a diagram illustrating an example of a configuration of a LSA packet including content location information according to an exemplary embodiment of the present invention;

FIG. 5 is a diagram illustrating in detail a configuration of a router-storage apparatus according to an exemplary embodiment of the present invention;

FIG. 6 is a diagram illustrating in detail a configuration of a content location finding apparatus according to an exemplary embodiment of the present invention;

FIG. 7 is a flow chart illustrating an operation method of a router-storage apparatus according to an exemplary embodiment of the present invention; and

FIG. 8 is a flow chart illustrating an operation method of a content location finding apparatus according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be appreciated by those of ordinary skill in the art. Descriptions of well-known functions and structures are omitted to enhance clarity and conciseness.

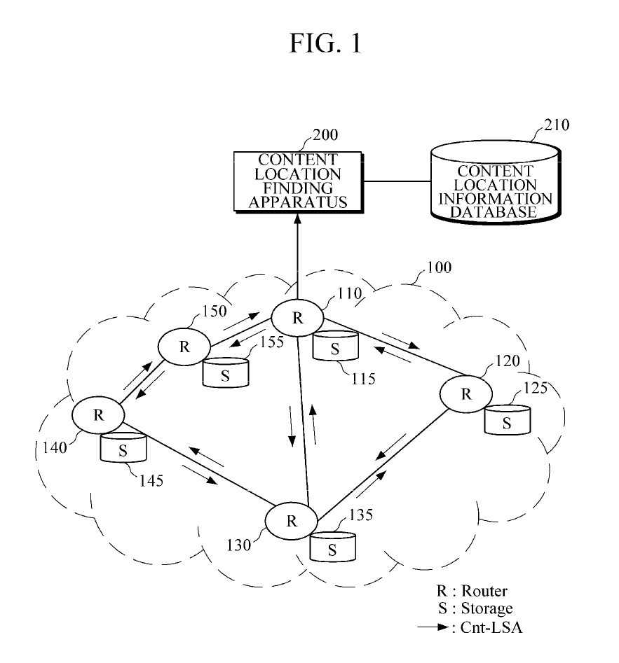

FIG. 1 is a diagram illustrating a configuration of a network composed of a plurality of routers, each having a storage, according to an exemplary embodiment of the present invention.

Referring to FIG. 1, the network 100 is composed of a plurality of routers 110, 120 . . . , 150 which use an OSPF routing protocol.

The Internet is a combination of networks in which a plurality of routers are connected to each other, and a packet to be routed from the source to the destination network has to pass through a number of routers to reach a router connected to the destination network. The router uses a routing protocol to find a path through which a received packet is transmitted to the destination network. However, the Internet has been broadly extended such that it is hard to renew routing tables of all routers using only one routing protocol. That is why a new concept of autonomous system has been introduced.

The autonomous system is a group of routers and networks managed by a single managing agency. Routing within one autonomous system is called interior routing while routing between autonomous systems is called exterior routing.

Examples of an interior gateway protocol used in IPv4 to perform the interior routing include Routing Information Protocol (RIP) and Open Shortest Path First (OSPF). Examples of an exterior gateway protocol used in Ipv4 to perform the exterior routing include Border Gateway Protocol (BGP).

An OSPF router, at intervals or only when a change happens in its state, transmits information about its path table to all routers of an area to which the OSPF router belongs using a data structure of a Link State Advertisement (LSA). According to the above operation of the OSPF router, the same location information can be shared between all routers of an area to which the OSPF router belongs. That is, each of routers belonging to a path OPSF routing domain uses the LSA to flood to adjacent routers state information of links connected to themselves. Routers which have received the LSA store LSA information in Link State Data Base (LSDB) and then flood the LSA information to all adjacent routers so that such routers may share link information about all of the routers belonging to the routing domain. In addition, the OSPF routers support an Opaque LSA, which is able to be applied in various applications, and provide a technique for extending existing OSFP routing protocols.

Referring to FIG. 1, the routers 110, 120, . . . , 150 may be respectively connected to storages 115, 125, . . . , 155 to store content. According to an exemplary embodiment of the present invention, each of the routers 110, 120, . . . , 150 may share content location information of content items stored in each of the storage 115, 125, . . . , 155 with one another. To this end, the routers 110, 120, . . . , 150 use the above-described LSA.

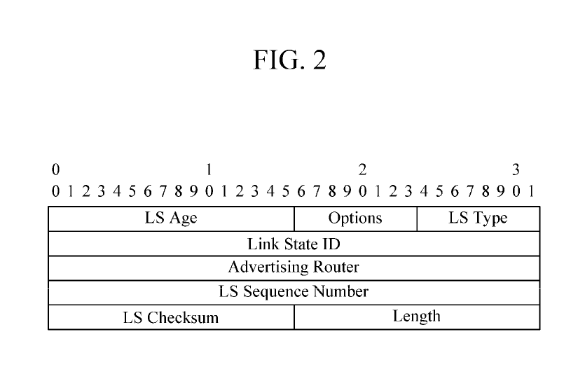

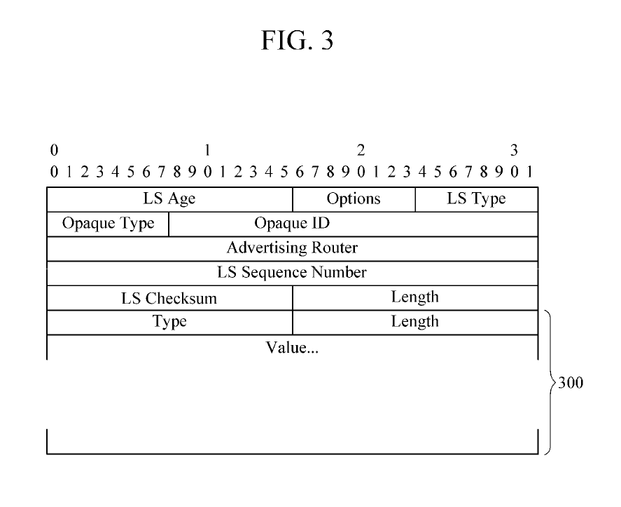

FIG. 2 is a diagram illustrating a format of a general OSPF LSA, and FIG. 3 is a diagram illustrating a format of an OSPF Opaque LSA applied in the present invention.

A 4-byte Link State ID region of LSA illustrated in FIG. 2 corresponds to a combination of a 1-byte Opaque Type region and a 3-byte Opaque ID region of Opaque LSA shown in FIG. 3. In addition, a payload of the Opaque LSA includes a Type-Length-Value (T-L-V) 300. In the present invention, the T-L-V 300 may include a content-item type and location information about where the content item is stored.

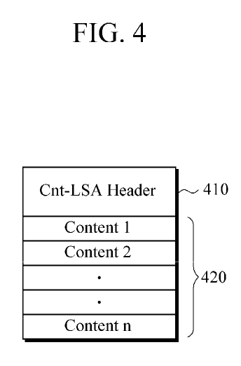

FIG. 4 is a diagram illustrating an example of a configuration of a LSA packet including content location information according to an exemplary embodiment of the present invention.

Referring to FIG. 4, the LSA packet includes a Cnt-LSA header and at least one piece of content location information, and the content location information is in the form of T-L-V as shown in FIG. 3.

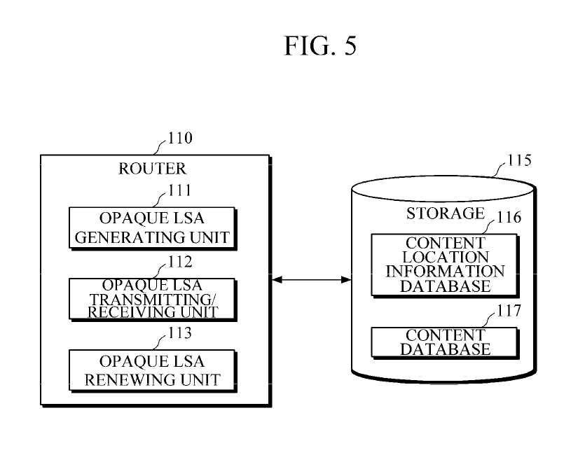

FIG. 5 is a diagram illustrating in detail a configuration of a router-storage apparatus according to an exemplary embodiment of the present invention.

Referring to FIG. 5, a router 100 includes an Opaque LSA generating unit 111, an Opaque LSA transmitting/receiving unit 112 and an Opaque LSA renewing unit 113 while the storage 115 of the router 100 includes a content location information database (DB) 116 and a content database (DB) 117.

The Opaque LSA generating unit 111 generates an Opaque LSA including at least one piece of content location information of content items stored in the storage 115. The content location information includes a content-item name and storage identifier information notifying in which storage the content item is stored. In addition, the Opaque LSA generating unit 111 monitors whether there is a change in the content location information of content items stored in its storage and then adds content location information of a new content item to the Opaque LSA or deletes content location information of a deleted content item from the Opaque LSA. At this time, the monitoring may be conducted at predetermined time intervals.

An Opaque LSA transmitting/receiving unit 112 floods the Opaque LSA generated from the Opaque LSA generating unit 111 to adjacent connected routers. In addition, the Opaque LSA transmitting/receiving unit 112 outputs the Opaque LSA received from the adjacent routers to the Opaque LSA renewing unit 113.

If there is content location information of a new content item in the Opaque LSA received from the Opaque LSA transmitting/receiving unit 112, the Opaque LSA renewing unit 113 modifies the content location information DB 116 of the storage 115 and floods the Opaque LSA received from the Opaque LSA transmitting/receiving unit 112 to other adjacent nodes.

According to the above-described operations, a plurality of routers may share content location information of content items stored in each of their own storages.

Back to FIG. 1 a content location finding apparatus 200 for notifying a user of content location information of content items stored in storages dedicated to each of a plurality of routers and a content location information database (DB) 210 are further illustrated. Although only one content location finding apparatus 200 is shown in FIG. 1, two or more content location finding apparatuses may be connected to the same router or different routers so as to provide content location information to a user terminal.

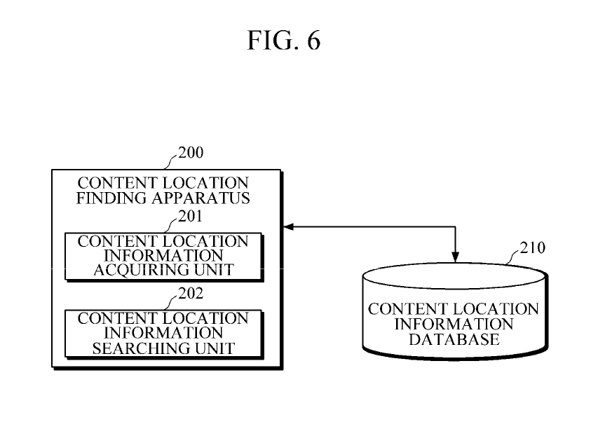

FIG. 6 is a diagram illustrating in detail a configuration of a content location finding apparatus according to an exemplary embodiment of the present invention.

Referring to FIG. 6, the content location finding apparatus 200 acquires s content location information from connected routers and stores/renews the content location information in a content location information DB 210, or, in response to a request from a user terminal, searches for the content location information in the content location information DB 210 and provide the found content location information to the user terminal.

To this end, the content location finding apparatus 200 includes a content location information acquiring unit 201 and a content location information searching unit 202.

The content location information acquiring unit 201 receives an Opaque LSA including content location information from a connected router and then extracting the content location information from the Opaque LSA and stores/renews the content location information in the content location information DB 210.

The content location information searching unit 202 searches for content location information of a content item requested from a user terminal in the content location information DB 210 and then provides the found content location information to the user terminal.

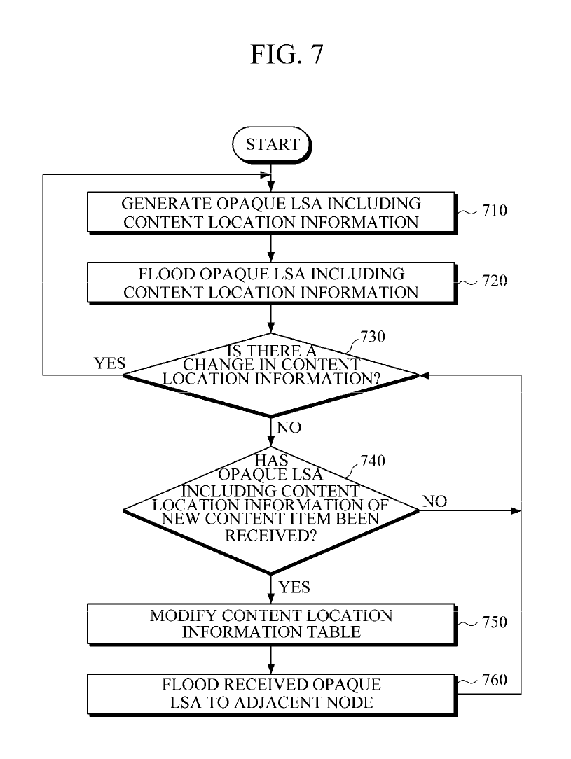

FIG. 7 is a flow chart illustrating an operation method of a router according to an exemplary embodiment of the present invention.

Referring to FIG. 7, the router generates an Opaque LSA including content location information upon execution in operation 710. The content location information includes a content-item name and storage identifier information notifying in which storage content is stored. In operation 720, the router adds to an extension field of the Opaque LSA the content location information notifying that the content item stored in a connected storage is stored in its own storage. Next, the router floods the generated Opaque LSA to adjacent connected routers.

Next, in operation 730, the router monitors whether there is a change in the content location information of content items stored in its storage. That is, it is determined whether a new content item is stored or whether a previously-stored content item is deleted. At this time, the monitoring may be conducted at predetermined time intervals.

If, according to the determination result of operation 730, it is determined that there is a change in the content location information, the router goes back to operation 710 and generates an Opaque LSA. That is, the router adds content location information of a new content item to the Opaque LSA or deletes content location information of a deleted content item from the Opaque LSA.

However, if it is determined that there is no change in the content location information according to the determination result of operation 730, the router, in operation 740, determines whether an Opaque LSA including the content location information of a new content item has been received. That is, it is determined whether the Opaque LSA including the content location information of a new content item has been received from adjacent routers.

If it is determined that the Opaque LSA including the content location information of a new content item has been received according to the determination result of operation 740, the router modifies the content location information of content items stored in the storage in operation 750 and floods the received Opaque LSA to other adjacent nodes in operation 760.

If, according the determination result of operation 740, it is determined that an Opaque LSA including the content location information of a new content item has not been received or that an Opaque LSA without the content location information of a new content item has been received, the router goes back to operation 730.

According to the above-described operations, a plurality of routers may share content location information of content items stored in each of their own dedicated storage.

Although it is described in the above that operations 710 to 760 are performed sequentially, operations 710 to 730 and operations 740 to 760 may be performed in parallel.

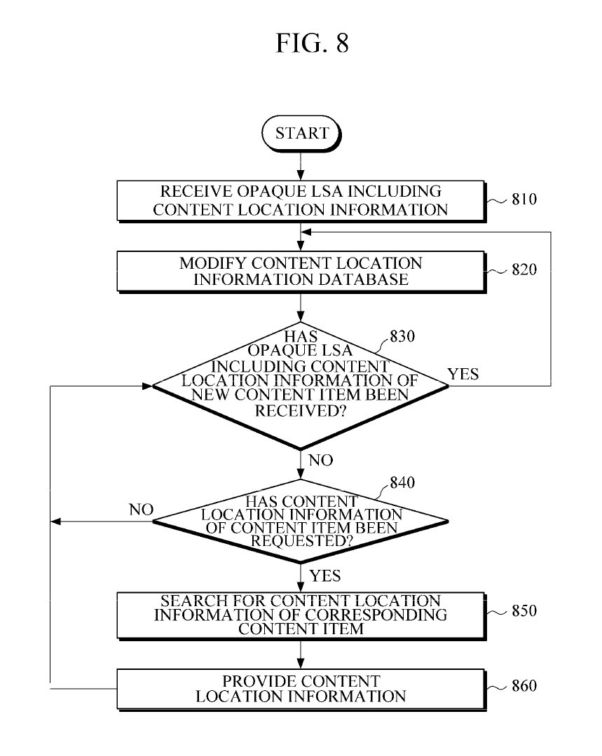

FIG. 8 is a flow chart illustrating an operation method of a content location finding apparatus according to an exemplary embodiment of the present invention.

As described above, a plurality of routers may share content location information according to the operations illustrated in FIG. 7. The present invention may use the content location finding apparatus connectable to such routers to provide the content location information to a user terminal.

Referring to FIG. 8, the content location finding apparatus receives an Opaque LSA including content location information from a connected router in operation 810. Next, in operation 820, the content location finding apparatus modifies a content location information database (DB) using the received Opaque LSA including content location information.

In operation 830, the content location finding apparatus determines whether the Opaque LSA including the content location information of a new content item has been received. That is, it is determined whether the Opaque LSA including the content location information of a new content item has been received from a connected router.

If, according to the determination result of operation 830, it is determined that the Opaque LSA including the content location information of a new content item has been received, the content location finding apparatus goes back to operation 820 and modifies the content location information DB using the newly received content location information.

If, according to the determination result of operation 830, it is determined that the Opaque LSA including the content location information of a new content item has not been received or that the Opaque LSA without the content location information of a new content item has been received, the content location finding apparatus proceeds with operation 840.

In operation 840, the content location finding apparatus determines whether content location information of a content item has been requested from a user terminal.

If, according to the determination result of operation 840, it is determined that the content location information of a content item has been requested from the user terminal, the content location finding apparatus searches for the content location information of the content item requested from the user terminal in the content location information DB in operation 850.

Next, the content location finding apparatus provides the found content location information to the user terminal in operation 860.

Although it is described in the above that operations 810 to 860 are performed sequentially, operations 810 to 830 and operations 840 to 860 may be performed in parallel.

The present invention is configured such that information and locations of entire content are integrated and managed on a network composed of a plurality of routers, each having a storage, so that such information and locations are easily provided to a user.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A router-storage apparatus, comprising:
a storage configured to store at least one content item; and
a router configured to be connected to the storage, generate an Opaque Link State Advertisement (LSA) including content location information of content items stored in the storage and flood the generated Opaque LSA to at least one adjacent router.

2. The apparatus of claim 1, wherein the Opaque LSA includes the content location information of two or more content items.

3. The apparatus of claim 1, wherein, in response to a change in the content items stored in the storage, the router generates a new Opaque LSA including content location information of a changed content item and floods the new Opaque LSA to the at least one adjacent router.

4. The apparatus of claim 3, wherein the router monitors whether there is a change in the content items stored in the storage at predetermined time intervals.

5. The apparatus of claim 1, wherein the storage stores the content location information and the router receives a new Opaque LSA from the at least one adjacent router to update the content location information stored in the storage.

6. The apparatus of claim 4, wherein the router floods the new Opaque LSA to at least one adjacent router.

7. A content location finding apparatus, comprising:
a content location information acquiring unit configured to acquire the content location information from a router on a network and store the content location information in a content location information database (DB); and
a content location information searching unit configured to search for content location information of a content item requested from a user terminal in the content location information DB and provide the found content location information.

8. The apparatus of claim 7, wherein the content location information acquiring unit extracts the content location information from Opaque LSA received from a router and stores the content location information in the content location information DB.

9. The apparatus of claim 7, wherein the content location information acquiring unit receives a new Opaque LSA from the router to update the content location information DB.

10. A method for sharing content location information with at least one router on a network, comprising:
generating an Opaque LSA including content location information of content items stored in a connected storage; and
flooding the generated Opaque LSA to at least one adjacent router.

11. The method of claim 10, wherein the generating of the Opaque LSA comprises, in response to a change in the content items stored in the storage, generating a new Opaque LSA including content location information of a changed content item.

12. The method of claim 10, further comprising:
receiving the new Opaque LSA from the at least one adjacent router to update the content location information stored in the storage.

13. The method of claim 12, further comprising:
flooding the new Opaque LSA to the at least one adjacent router.

14. A method for finding content location in a content location finding apparatus connected to a content location information DB, comprising:
acquiring content location information from a router on a network and storing the content location information in the content location information DB; and
searching for content location information of a content item requested from a user terminal in the content location information DB and providing the found content location information.

15. The method of claim 14, wherein the storing of the content location information comprises extracting an Opaque LSA received from the router and storing the content location information in the content location information DB.

16. The method of claim 14, wherein the storing comprises receiving a new Opaque LSA from the router to update the content location information DB.

17. A system for providing content location information, comprising:
at least one router-storage apparatus configured to be connected to a storage, generate an Opaque LSA including content location information of content items stored in the storage, and flood the generated Opaque LSA to at least one adjacent router; and
at least one content location finding apparatus configured to be connected to the at least one router-storage apparatus, acquire content location information, store the content location information in a content location information DB, search for content location information of a content item requested from a user terminal in the content location information DB and provide the found content location information.
